(19) United States
(12) Patent Application Publication
(10) Pub. No.: US 2009/0040476 A1
(43) Pub. Date: Feb. 12, 2009

(54) PROJECTOR APPARATUS AND CONTROL METHOD FOR PROJECTOR APPARATUS

(75) Inventor: Hidekazu Masukawa, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/187,303

(22) Filed: Aug. 6, 2008

(30) Foreign Application Priority Data
Aug. 10, 2007 (JP) 2007-210169

(51) Int. Cl. G03B 21/20

(52) U.S. Cl. 353/85

(57) ABSTRACT

According to one embodiment, a projector apparatus comprises a modulator configured to modulate light emitted from a light source in accordance with an image signal, a projection lens configured to project an optical image emitted from the modulator, a detector configured to detect whether or not an optical path of the projection lens is interrupted by a lens cover, a time measurement unit configured to measure an elapsed time after the optical path is interrupted by the lens cover, and a power controller configured to turn a power off when the time measured by the time measurement unit exceeds a predetermined time period.

### CROSS-REFERENCE TO RELATED APPLICATIONS

This application is based upon and claims the benefit of priority from Japanese Patent Application No. 2007-210169, filed Aug. 10, 2007, the entire contents of which are incorporated herein by reference.

### BACKGROUND

1. Field

One embodiment of the present invention relates to a projector apparatus and a control method for the projector apparatus.

2. Description of the Related Art

A projector apparatus is a display apparatus that displays image information on a large screen. In the projector apparatus, light emitted from a light source such as a high-pressure mercury lamp is modulated by use of a modulator such as a liquid crystal panel, and is projected on a screen through a projection lens. Since the projection lens easily becomes damaged and dusty, a lens cover is provided to protect the projection lens from damage and dust.

Projection of an image is performed in a state in which the lens cover is open. When the user tries to temporarily stop image projection, the lens cover may be closed to interrupt an optical image projected from the projection lens. In such a case, if the light source continues light emission, the lens cover keeps irradiated with the light from the projection lens. Therefore, the temperature of the lens cover becomes high due to the light irradiation and the lens cover may be melted and deformed in some cases.

In a projector described in Jpn. Pat. Appln. KOKAT Publication No. 2004-245986, when a lens cap is attached on a projection lens, a modulator executes modulation so that light from a light source is shielded or dimmed, which prevents the lens cap from melting.

According to the above projector apparatus, in the case where the lens cover is attached on the projection lens, even though the light source itself continues light emission, light from the light source is shielded and any image is not projected on a screen. Therefore, after interrupting the image projection, if the user carries out another operation, the fact that the projection is interrupted may be forgotten while the power source of the projector apparatus keeps to be turned on. The light source lamp continues light emission even though the user forgets that the power source of the projector apparatus keeps turned on. Accordingly, heat generated from the lamp rises temperature of the lens cover making the lens cover to be deformed. Furthermore, when it is omitted to turn off the power source, wasteful power may be consumed and life of the lamp may be shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary external view showing an appearance of a projector apparatus with a lens cover open according to an embodiment of the invention;

FIG. 2 is an exemplary external view showing an appearance of the projector apparatus with the lens cover closed according to the embodiment of the invention;

FIG. 3 is an exemplary block diagram showing an electronic configuration of the projector apparatus according to an embodiment of the invention; and

FIG. 4 is an exemplary flowchart showing a process executed by the projector apparatus according to the embodiment.

### DETAILED DESCRIPTION

Various embodiments according to the invention will be described hereinafter with reference to the accompanying drawings. In general, according to one embodiment of the invention, a projector apparatus comprises a modulator configured to modulate light emitted from a light source in accordance with an image signal, a projection lens configured to project an optical image emitted from the modulator, a detector configured to detect whether or not an optical path of the projection lens is interrupted by a lens cover, a time measurement unit configured to measure an elapsed time after the optical path is interrupted by the lens cover, and a power controller configured to turn a power off when the time measured by the time measurement unit exceeds a predetermined time period.

There will now be described an embodiment of a projector apparatus according to the present invention with reference to the accompanying drawings.

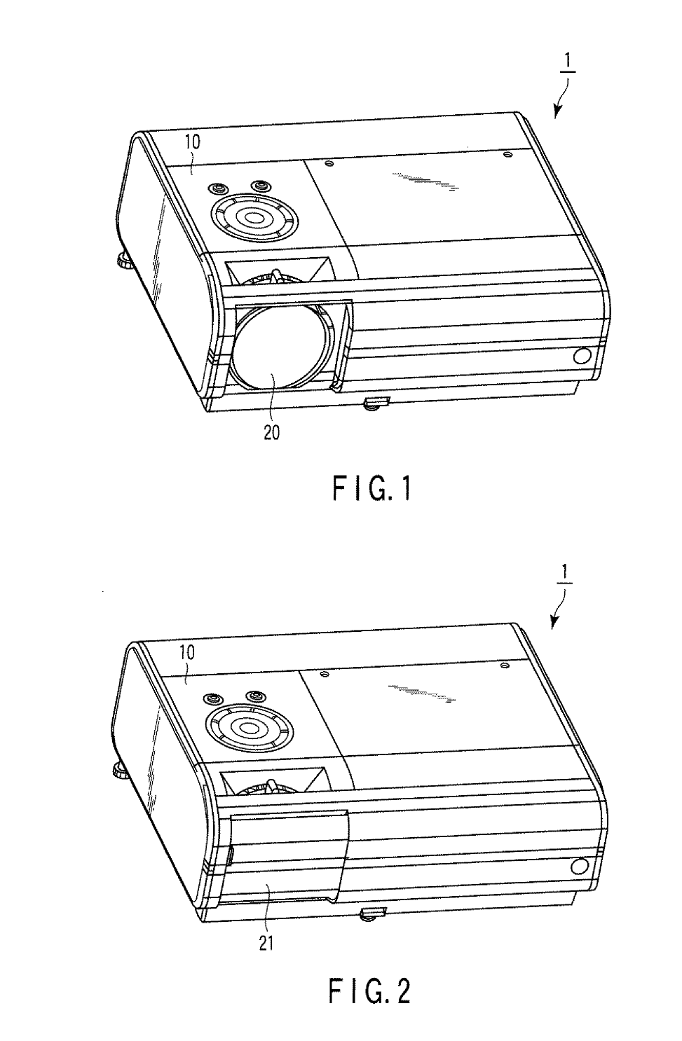

FIG. 1 is an exemplary external view showing an appearance of a projector apparatus with a lens cover open according to an embodiment of the invention. An operating unit 10 is provided on the upper surface of the projector apparatus 1. The operating unit 10 includes a power button, various function buttons and the like. A projection lens 20 is arranged on the front surface of the projector apparatus 1. An optical image corresponding to an image signal inputting to the projector apparatus 1 is irradiated from the projection lens 20 and projected onto a screen.

FIG. 2 is an exemplary external view showing an appearance of the projector apparatus with the lens cover closed according to the embodiment. A lens cover 21 slides laterally and covers the front of the projection lens 20 to protect the projection lens 20.

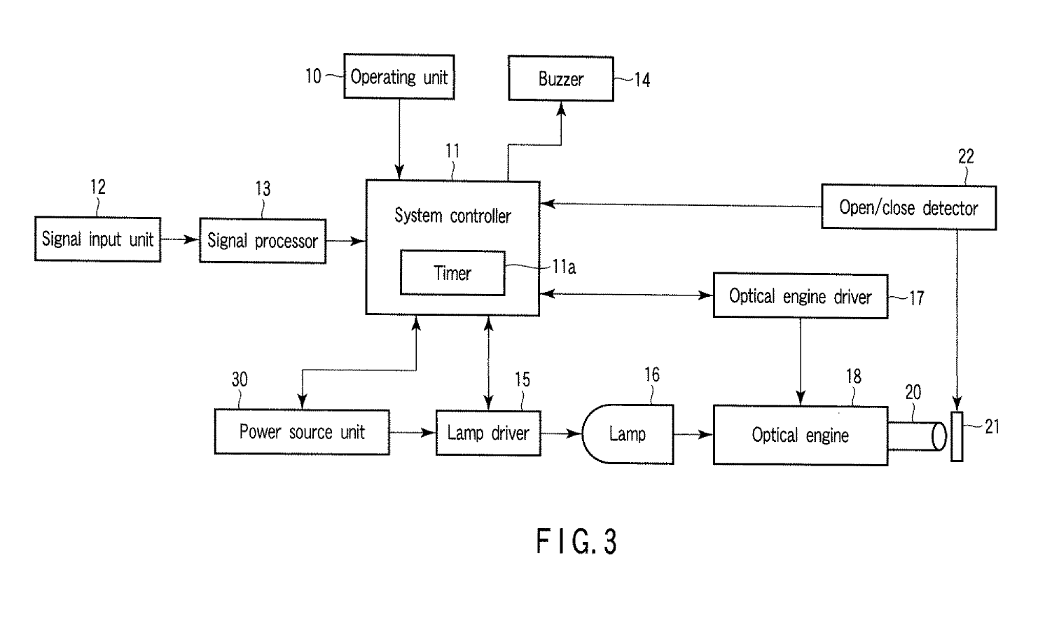

FIG. 3 is an exemplary block diagram showing an electronic configuration of the projector apparatus.

The operating unit 10 includes a power button, various function buttons, a display panel and the like. The user can supply an operation instruction to a system controller 11 by operating the operating unit 10.

A system controller 11 includes a CPU and storage device such as a ROM and a RAM, which are not shown in the drawings. The system controller 11 controls the operations of the components of the projector apparatus 1 in accordance with a control program stored in the storage device. The system controller 11 includes a timer 11a. The timer 11a is started when the lens cover 21 is closed, and measures a time elapsed after the lens cover 21 is closed. The system controller 11 stops driving the timer 11a when the lens cover 21 is opened.

A signal input unit 12 includes image signal input terminals for plural input lines including an S-video terminal, a DVI-I terminal, and a D-sub terminal. The signal input unit 12 receives an image signal such as an RGB signal, a video signal, an image signal from a personal computer (PC), and an image signal from an optical disk apparatus such as a DVD drive, via the above image signal input terminals. An image signal input to the signal input unit 12 is sent to a signal processor 13. The signal processor 13 performs predetermined signal processing on the input image signal, and converts the signal into an image signal having a format corresponding to display elements of an optical engine 18.

When a preset period of time has elapsed from closing the lens cover 21, a buzzer 14 generates an alarm sound under the control of the system controller 11 to alert a user.

A lamp driver 15 includes a lamp power circuit for driving a lamp 16. The lamp driver 15 drives the lamp 16 under the control of the system controller 11. The lamp 16 emits light and applies the emitted light to the optical engine 18. The lamp 16 includes a high-pressure mercury lamp, for example.

An optical engine driver 17 drives the optical engine 18 under the control of the system controller 11. For example, a three-LCD system may be employed as a projection system of the optical engine 18. In the optical engine of the three-LCD system, three liquid crystal panels are used as display elements. Dichroic mirrors separate the light emitted from the lamp 16 into three colors of light, i.e., red (R), green (G) and blue (B). The separated light beams of respective colors strike the liquid crystal panels of corresponding colors. The optical engine driver 17 controls the transmittances and reflectances for the light beams striking the liquid crystal panels in accordance with the input image signal. A dichroic prism combines the separated R, G, and B light beams again. The combined light is emitted and projected onto the screen through the projection lens 20.

The lens cover 21 covers the front surface of the projection lens 20 to protect the projection lens 20. An opening and closing detector (open/close detector) 22 has a function of detecting whether the lens cover 21 is open or closed. When a user opens the lens cover 21, the opening and closing detector 22 sends an opening detection signal to the system controller 11.

A power source unit 30 supplies power, which is required for driving the respective portions of the projector apparatus 1, to the system controller 11. The power source unit 30 also supplies power to the lamp driver 15. The power source unit 30 may be contained within the projector apparatus 1. Alternatively, the power source unit 30 may be provided outside the projector apparatus i and may supply power thereto via a power terminal.

There may be a case in which a user closes the lens cover 21 to shield an optical path of the projection lens 20 and interrupts an optical image projected from the projection lens 20. In such a case, if the lamp 16 continues light emission, the light keeps striking the lens cover 21 through the projection lens 20. Therefore, the temperature of the lens cover 21 becomes high and the lens cover 21 may be melted and deformed.

In the present embodiment, to prevent cutting off the power source from being omitted while the lens cover 21 is closed, power supply from the power source unit 30 is stopped and the power of the projector apparatus 1 is automatically cut off when a preset period of time has elapsed after closing the lens cover 21.

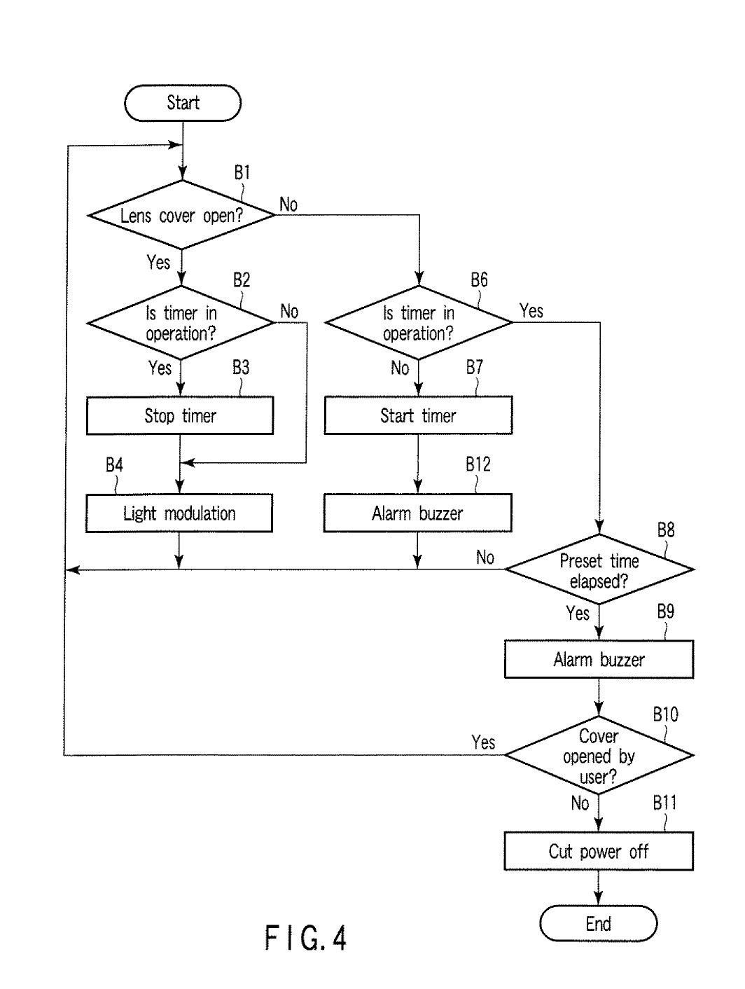

To be explained next is the operation of the projector apparatus 1 which has the above configuration. FIG. 4 is an exemplary flowchart showing a process executed by the projector apparatus.

When the projector apparatus 1 is started, the system controller 11 determines whether or not the lens cover 21 is open (block B1).

When the lens cover 21 is open, the opening and closing detector 22 sends an opening detection signal to the system controller 11. When receiving the opening detection signal sent from the opening and closing detector 22, the system controller 11 determines that the lens cover 21 is open (YES in block B1)

When it is determined that the lens cover 21 is open (YES in block B1), then the system controller 11 determines whether or not the timer 11a is in operation (block B2).

The timer 11a starts time measurement when the lens cover 21 is closed and measures the time elapsed after closing the lens cover 21. That is, it is determined that the timer 11a is in operation if it is immediately after the lens cover 21, which has kept closed, is opened (YES in block B2).

When it is determined that the timer 11a is in operation (YES in block B2), the system controller 11 stops the operation of the timer 11a (block B3). When it is determined that the timer 11a is not in operation (NO in block B2), the flow goes to block B4.

Subsequently, the optical engine driver 17 drives the optical engine 18 under the control of the system controller 11 and modulates light emitted from the lamp 16 according to an input image signal (block B4). A color image corresponding to the input image signal is projected onto a screen through the projection lens 20, and then the flow returns to block B1.

When the opening detection signal is not supplied from the opening and closing detector 22, the system controller 11 determines that the lens cover 21 is closed (NO in block B1). The system controller 11 determines whether or not the timer 11a is in operation (block B6).

Immediately after the lens cover 21 is closed, the system controller 11 determines that the timer 11a is not in operation (NO in block B6) and starts the timer 11a (block 37). Then, the system controller 11 causes the buzzer 14 to generate an alarm sound (block B12), and the flow returns to block B1.

On the other hand, when the timer 11a is already started and executing time measurement (YES in block S6), it is determined in block B8 whether or not the time elapsed from closing of the lens cover 21 (from start-up of the timer 11a), which is measured by the timer 11a, exceeds a preset period of time (30 minutes, for example).

When the time elapsed from the closing of the lens cover 21 (from the start-up of the timer 11a) does not exceed the preset period of time (NO in block B8), the flow returns to the block B1.

Afterward, when the user opens the lens cover 21 (YES in block B1), it is determined that the timer 11a is in operation (YES in block B2), and then the system controller 11 stops the timer 11a executing the time measurement (block B3). Then, the system controller 11 causes the optical engine 18 to perform light modulation according to an input image signal (block B4). A color image corresponding to the input image signal is projected from the projection lens 20.

When the preset period of time (for example, 30 minutes) has elapsed from the closing of the lens cover 21 (from the start-up of the timer 11a) (YES in block B8), the system controller 11 causes the buzzer 14 to generate an alarm sound (block B9). Generation of the alarm sound notifies the user that the preset period of time has elapsed after closing the lens cover 21. Even when the user is carrying out another operation while projection of an image is kept stopped, the user can notice by the alarm sound that the power of the projector apparatus 1 remains turned on.

When the user opens the lens cover 21 (YES in block B10), the flow returns to the block B1. Opening of the lens cover 21 is detected (YES in block B1), it is determined that the timer 11a is in operation (YES in block B2), and then the system controller 11 stops the timer 11a executing the time measurement (block B3). Afterward, the system controller 11 causes the optical engine 18 to perform light modulation according to an input image signal/block 54). A color image corresponding to an input image signal is projected from the projection lens 20.

When the lens cover 21 remains closed even though the alarm sound is generated (NO in block B10), power supply from the power source unit 30 is stopped and the power source of the projector apparatus 1 is cut off (block B11) That is, when the lens cover 21 remains unopened for the preset period of time after the lens cover 21 is closed, it is determined that the user has quitted using the projector apparatus 1 and the power source of the projector apparatus 1 is cut off.

The user can recognize by the alarm generated from the buzzer 14 that the preset period of time has elapsed from the time when the lens cover 21 Is closed. When the user desires to restart image projection, the image projection can be restarted simply by opening the lens cover 21. Furthermore, when the user determines to cut off the power source of the projector apparatus 1 as it is, or when the user does not notice the alarm sound since the user is away from the projector apparatus 1 not remembering that the power source of the projector apparatus 1 remains turned on, the power source of the projector apparatus 1 is cut off. As a result, a rise in temperature of the lens cover 21 and unwanted power consumption can be suppressed.

As described above, in the present embodiment, the opening and closing detector 22 detects whether the lens cover 21 is open or closed. When the preset period of time has elapsed after closing the lens cover 21, the buzzer 14 generates the alarm sound. Even when the user does not remember that image projection is being stopped temporarily, alerting can be maid by generation of the alarm sound. When the user hears the alarm sound and opens the lens cover 21, image projection is restarted. In the case where the lens cover 21 is not opened even though the buzzer 14 generates the alarm sound, power supply from the power source unit 30 is stopped and the power of the projector apparatus 1 is cut off. That is, even though the user omits to turn off the power of the projector apparatus 1 while image projection is being interrupted, the power source of the projector apparatus 1 is automatically cut off when the preset period of time has elapsed. Thus, a rise in temperature of the lens cover 21 can be prevented from occurring and unwanted power consumption can be suppressed.

In the present embodiment, when the preset period of time has elapsed from closing of the lens cover 21, the buzzer 14 generates the alarm sound to alert the user. However, a way of alerting user is not necessarily limited to generation of the alarm sound. It is also possible to arrange an LED lamp or the like on the operating unit 10 and cause the LED lamp to emit (or flickers light.

In the present embodiment, immediately after the lens cover 21 is closed (NO in block B6), the timer 11a is started (block B7), and the buzzer 14 generates the alarm sound (block B12). Thus, the user can recognize that the lens cover 21 is closed. If the lens cover 21 is closed despite intention of the user, alerting the user is possible by the alarm sound generated from the buzzer 14. The alarm sound generated in block B12 may be the same as the alarm sound generated in block B9, or the alarm sounds can be different from each other. Alternatively, an LED lamp or the like may be arranged on the operating portion 10 and the LED lamp may be caused to emit (or flicker) light.

In the present embodiment, in the case where the lens cover 21 is kept closed for the preset period of time (for example, 30 minutes), the power supply from the power source unit 30 to the system controller 11 and lamp driver 15 is stopped and the power source of the projector apparatus 1 is cut off. However, merely power supply from the power source unit 30 to the lamp driver 15 may be interrupted and power supply to the system controller 11 may be maintained. Alternatively, when the lens cover 21 is kept closed for a first preset period of time (for example, 10 minutes), power supply to the lamp driver 15 may be interrupted. Then, when the lens cover is further kept closed for a second preset period of time (for example, 20 minutes), the power of the projector apparatus 1 may be turned off. Since the lamp power is lowered when the first preset period of time has elapsed, power consumption can be suppressed.

In the present embodiment, explained is a case in which the lens cover 21 is laterally slid to shield the optical path of the projection lens 20. However, the lens cover 21 may be opened or closed in a vertical direction. Moreover, the lens cover 21 may be attached to or removed from the projection lens 20. The lens cover 21 can be formed with a desired configuration if it shields the optical path of the projection lens 20.

In the present embodiment, a high-pressure mercury lamp is used as the lamp 16, but another Lamp may be used. Further, the three-LCD system is employed as the projection system of the optical engine 18; however, another projection system such as a DLP (registered trademark) system or LOOS system can be employed

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projector apparatus comprising:
a modulator configured to modulate light emitted from a light source in accordance with an image signal;
a projection lens configured to project an optical image emitted from the modulator;
a detector configured to detect whether or not an optical path of the projection lens is interrupted by a lens cover;
a time measurement unit configured to measure an elapsed time after the optical path is interrupted by the lens cover; and
a power controller configured to turn a power off when the time measured by the time measurement unit exceeds a predetermined time period.

2. The projector apparatus according to claim 1, further comprising a notification unit configured to notify a user that the elapsed time measured by the time measurement unit exceeds the predetermined time period.

3. The projector apparatus according to claim 2, wherein the notification unit generates an alarm sound when the elapsed time measured by the time measurement unit exceeds the predetermined time period.

4. The projector apparatus according to claim 1, the time measurement unit starts measuring the elapsed time when the detector detects that the optical path of the projection lens is interrupted by the lens cover, and stops measuring the elapsed time when the detector detects that the optical path is not interrupted by the lens cover.

5. The projector apparatus according to claim 2, wherein the notification unit notifies the user that the detector detects that the optical path of the projection lens is interrupted by the lens cover.

6. A control method for a projector apparatus which includes a modulator configured to modulate light emitted from a light source in accordance with an image signal, and a projection lens configured to project an optical image emitted from the modulator, the control method comprising:
detecting whether or not an optical path of the projection lens is interrupted by a lens cover;
measuring an elapsed time after the optical path is interrupted by the lens cover; and
turning a power off when the measured elapsed time exceeds a predetermined period time.

7. The control method for a projector apparatus according to claim 6, further comprising notify a user that the elapsed time measured by the time measurement unit exceeds the predetermined time period.
